(19) United States
(12) Patent Application Publication
(10) Pub. No.: US 2007/0016660 A1
(43) Pub. Date: Jan. 18, 2007

(54) JavaServer Faces Upload

(75) Inventor: Garret Wilson, San Francisco, CA (US)

Correspondence Address: GLOBALMENTOR, INC., 7655 S. HIGHWAY 28, CHELSEA, OK, 74016, US

(73) Assignee: GLOBALMENTOR, INC., Chelsea, OK (US)

(21) Appl. No.: 11/160,628

(22) Filed: Jun. 30, 2005

(51) Int. Cl. G06F 15/177

(52) U.S. Cl. 709/220

(57) ABSTRACT

This invention consists of a custom JavaServer Faces UIForm component (“UIFileUploadForm”), a custom JavaServer Faces UIInput component (“UIFileUploadInput”), and a corresponding process which allows file uploads to be implemented within JavaServer Faces without the need for a separate servlet filter.

The JavaServer Faces (“JSF”) framework provides no native functionality for uploading files to a server. One JSF implementation and library, MyFaces, provides a specialized UIInput component of type “file”, but requires a separate Java Servlet filter to actually perform file uploading. This invention consists of a custom JSF UIForm component (“UIFileUploadForm”), a custom JSF UIInput component (“UIFileUploadInput”), and a corresponding process which allows file uploads to be implemented within JSF without the need for a separate servlet filter.

A version of this description has been posted to the JSF forum (http://forum.java.sun.com/thread.jspa?threadID=464060&messageID=2814907) and the invention has been successfully reproduced by persons skilled in the art of JSF using the description.

This invention may be implemented by following these three steps:

(1) Create a custom UIForm to handle multipart form encodings and correctly set the FacesContext.ExternalContext request parameters.

(2) Create an implementation-agnostic file item interface or use an existing file item interface such as the Apache Commons FileUpload FileItem object to encapsulate uploaded file information.

(3) Create a custom UIFileUploadInput component that in getConvertedValue( ) either returns the file contents or stores them in the given directory and optional filename.

This invention uses a specialized descendant of UIForm, UIFileUploadForm, and overrides the processDecodes( ) method. Here, a check is performed to see if there is multipart content (“multipart/form-data”), and if so, the component looks through all the form fields to see if the HTTP request is for the specialized UIForm. If it is, the custom processDecodes( ) method adds all the multipart form fields to the map of parameters in the method's ExternalContext object, and then allows decoding to process normally. Once the multipart data is added to the ExternalContext, all the child components, and even the form itself, go through the JSF decode process normally, as they see the form data they would expect were a normal HTTP POST form submission to occur using “multipart/form-data”.

The map returned by ExternalContext.getRequestParameterMap( ) is immutable, so this invention includes a FacesContext decorator that delegates to the real FacesContext except for getExternalContexto, which returns an ExternalContext decorator that delegates to the real ExternalContext except for the request parameter-related methods, which returns the request parameters from the multipart form data.

As with all custom components in JSF, the UIFileUploadForm described must be placed inside the faces-config.xml file, such as in the following example (assuming that the class name of the custom UIForm is com.garretwilson.faces.component.UlFileUploadForm):

```
    <component>
        <component-type>javax.faces.Form</component-type>
        <component-
class>com.garretwilson.faces.component.UIFileUploadForm</component-
class>
    </component>
```

UIFileUploadForm at this point allows multipart form data to be submitted to the server while still allowing standard JSF components, which do not normally understand multipart form data, to work with the the UIFileUploadForm component. This invention requires a separate custom UIInput component, UIFileUploadInput, to actually process each uploaded file. UIFileUploadForm first prepares any uploaded file data to be used by UIFileUploadInput in the following manner.

When UIFileUploadForm encounters data that is not a form field (i.e. the data is file upload data), UIFileUploadForm stores the actual file data as the value of the request parameter in the aforementioned FacesContext.ExternalContext request parameter map. The actual format of the upload file data is implementation dependent. The best mode of this invention uses the Apache Commons FileUpload FileItem object as an encapsulation of the uploaded file data. The rest of this description assumes that such a FileItem object is stored as a request parameter, but this invention may be used with any suitable encapsulation of uploaded file data.

The custom UIInput component, UIFileUploadInput, allows uploaded file data to be stored either in the standard JSF UIInput.value property, or stored directly in a file in the server's filesystem. If uploaded file data is stored as a FileItem and should ultimately be stored in the UIInput.value property, it must first be converted. UIFileUploadInput performs this conversion in UIFileUploadInput.getConvertedValue( ). UIFileUploadInput does several things (assuming the InputFile renderer has used setSubmittedValue( ) as normal with whatever value was in the request parameter—in this case a FileItem):
(1) Is the value a FileItem (in which case it should be converted)?
(2) If so, convert the file contents to a string and return them. (Binary files can be returned as an array of bytes).

This allows storing of text files easily, as shown in the following JSF example:

```
    <gwjsf:uiFileUploadForm enctype=“multipart/form-data”>
        <gwjsf:uiFileUploadInput id=“fileInputField”
value=“#{documentUploadBean.test}”/>
          <gwjsf:commandButton id=“acceptButton”>
          <html:graphicImage styleClass=“icon”
url=“/images/icons/accept.gif” alt=“Upload”/>
          <jsf:verbatim>Upload</jsf:verbatim>
        </gwjsf:commandButton>
    </gwjsf:uiFileUploadForm>
```

In the above example, another component can simply display the contents of #{documentUploadBean.test}.

UIFileUploadInput can also store files directly on the file system its custom UIFileUploadInput.directory and UIFileUploadInput.filename properties. If UIFileUploadInput.directory has a value, UIFileUploadInput.getConvertedValue( ) stores the contents of the file in that directory and returns null. If UIFileUploadInput.filename is provided, this overrides the submitted filename. (As might be expected both properties support value binding expressions.) This is used as follows in the actual JSF file:

```
  <gwjsf:uiFileUploadForm enctype=“multipart/form-data”>
    <gwjsf:uiFileUploadInput id=“fileInputField” directory=“D:\temp”>
    <gwjsf:commandButton id=“acceptButton”>
      <html:graphicImage styleClass=“icon”
url=“/images/icons/accept.gif” alt=“Upload”/>
      <jsf:verbatim>Upload</jsf:verbatim>
    </gwjsf:commandButton>
  </gwjsf:uiFileUploadForm>
```

UIFileUploadInput therefore works with value-changed listeners, action listeners, and the like. Multiple input fields can be used that either set backing bean values or store files in the file system, independently. Other normal fields, buttons, calendar controls, and whatever can be interspersed and will function as expected.

The logic of UIFileUploadInput.getConvertedValue( ) is as follows:
(1) Is the submitted value a FileItem?
(2) If so, is there a directory and/or filename? If so, store the file contents.
(3) Otherwise, is the FileItem a text file (i.e. its content type is text/*, application/*+xml, etc.)? If so, convert it to a string and return it. Otherwise, return an array of bytes.

This invention's UIFileUploadForm therefore requires no servlet filter, and allows normal buttons and other components which work correctly even with enctype=“multipart/form-data”. The other buttons fire their actions normally. If the UIFileUploadInput component is used to submit a file, the component will correctly save the file in whatever directory UIFileUploadInput.directory specifies.

What is claimed is:

1. A set of custom JavaServer Faces (“JSF”) components for allowing file upload functionality comprised of the following components: A) a custom UIForm component with means for recognizing the “multipart/form-data” HTTP MIME encoding type; and for storing form data and file upload data in the FacesContext.ExternalContext request parameter map for access by contained JSF standard and custom components, and B) a custom UIInput component with means for processing uploaded file data.

2. The components of claim 1 wherein component A uses the decorator pattern to encapsulate the default FacesContext and provide access to a custom ExternalContext.

3. The components of claim 2 wherein said custom ExternalContext uses the decorator pattern to encapsulate the default ExternalContext and provide access to stored form data and file upload data.

4. The components of claim 1 wherein component A) stores uploaded file data encapsulated in a Apache Commons FileUpload FileItem object.

5. The components of claim 1 wherein component B) stores uploaded file data in a variable using the JSF value binding facility.

6. The components of claim 1 wherein component B) stores uploaded file data in a file on the server.

7. A method of uploading file data using JavaServer Faces comprising the steps of: A) storing uploaded file data submitted in “multipart/form-data” HTTP MIME encoding format in a FacesContext.ExternalContext request parameter map, and B) processing the uploaded file data stored in said FacesContext.ExternalContext request parameter map.

8. The method of claim 7 wherein the uploaded file data is stored in a variable using the JSF value binding facility.

9. The method of claim 7 wherein the uploaded file data is stored in a file on the server.

10. The method of claim 7 wherein non-uploaded-file-data is stored in a FacesContext.ExternalContext request parameter map so as to be accessible by standard JSF forms.
